(19) United States
(12) Patent Application Publication
(10) Pub. No.: US 2012/0236447 A1
(43) Pub. Date: Sep. 20, 2012

(54) INPUT-OUTPUT ESD PROTECTION

(76) Inventors: Michael P. MACK, Sunnyvale, CA (US); Sunetra Mendis, Palo Alto, CA (US)

(21) Appl. No.: 13/179,415

(22) Filed: Jul. 8, 2011

Related U.S. Application Data
(60) Provisional application No. 61/452,303, filed on Mar. 14, 2011.

(51) Int. Cl. H02H 9/00

(52) U.S. Cl. 361/56

(57) ABSTRACT

A method and apparatus for protecting an input-out (I/O) circuit against electro-static discharge (ESD) events. An ESD circuit used to protect the I/O circuit against an ESD event is coupled to the I/O circuit. The ESD circuit includes a diode clamp circuit that couples an I/O pad to a power supply and a ground pad. The ESD circuit further includes an active clamp circuit that is configured to clamp the I/O pad without turning on the diode clamp circuit during the ESD event.

### CROSS-REFERENCE TO RELATED APPLICATION

This application claims the benefit under 35 USC 119(e) of the co-pending and commonly owned U.S. Provisional Application No. 61/452,303 entitled “INPUT-OUTPUT ESD PROTECTION” filed on Mar. 14, 2011, the entirety of which is incorporated herein by reference.

### TECHNICAL FIELD

The present embodiments relate generally to integrated circuits and specifically relate to improved input-output ESD protection.

### BACKGROUND OF RELATED ART

An electro-static discharge (ESD) event can occur between any two bodies that are at different potentials. The ESD event may be initiated by a contact or an ionized ambient discharge or spark between two charged bodies, and can result in transfer of energy between the two charged bodies. For example, a person can become charged after walking on an electro-statically charged surface (or handling a charged object), and may then inadvertently transfer this charge to an electronic circuit by touching the circuit.

In some circumstances, ESD events can inflict serious damage to electronic circuits. For example, a catastrophic ESD event in an electronic circuit may cause a metal layer to melt, an oxide layer to fail, or a junction to break. Less serious ESD events can cause latent failures, which may not be catastrophic, but may compromise performance characteristics of the electronic circuit. Various solutions have been used to protect electronic circuits by diverting damaging discharges away from sensitive circuitry through specially designed circuits.

One commonly used ESD solution involves the use of NMOS transistor devices as snap-back devices. Snap-back behavior of the NMOS snap-back device involves the inherent bipolar n-p-n transistor formed by the n+ source and drain regions and the p− substrate of the NMOS device. When a high voltage (e.g., resulting from an ESD event) appears between the source and drain terminals of the NMOS device, the n-p-n transistor turns on and diverts the resulting high discharge current to the substrate, which in turn passes the discharge current to ground potential.

More recently, ESD protection circuits that include a diode clamp and an active clamp have been used. Although effective for protecting against many ESD events, conventional active clamp circuits may not sufficiently protect the integrated circuit during certain forced ESD events that are performed during ESD testing of the integrated circuit. Thus, there is a need for an improved ESD circuit that can provide more comprehensive ESD protection than conventional circuits.

### BRIEF DESCRIPTION OF THE DRAWINGS

The present embodiments are illustrated by way of example and are not intended to be limited by the figures of the accompanying drawings, where:

FIG. 1 is a block diagram of an integrated circuit within which the present embodiments may be implemented;

FIG. 2 is a block diagram of a circuit including an I/O circuit of FIG. 1 connected to an I/O pad and protected by an electro-static discharge (ESD) circuit;

FIG. 3 is a schematic diagram of a conventional ESD circuit;

FIG. 4 is a schematic diagram of an ESD circuit in accordance with some embodiments; and

FIG. 5 is a flow chart illustrating a method for protecting an I/O circuit against an ESD event in accordance with some embodiments.

Like reference numerals refer to corresponding parts throughout the drawing figures.

### DETAILED DESCRIPTION

A method and apparatus for protecting an input/output (I/O) circuit against ESD events are disclosed. In the following description, numerous specific details are set forth such as examples of specific components, circuits, and processes to provide a thorough understanding of the present disclosure. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. The term “coupled” as used herein means connected directly to or connected through one or more intervening components or circuits. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of myriad physical or logical mechanisms for communication between components. As another example, circuits described or depicted as including metal oxide semiconductor (MOS) transistors may alternatively be implemented using bipolar transistors or any other technology in which a signal-controlled current flow may be achieved. The present embodiments are not to be construed as limited to specific examples described herein but rather includes within its scope all embodiments defined by the appended claims.

An ESD protection circuit is disclosed that protects an integrated circuit (IC) device against ESD events in a more comprehensive manner than conventional techniques. The ESD protection circuit is coupled to I/O circuitry and various pads (or pins) of the IC device, and is configured to protect the I/O circuit from ESD events. More specifically, for some embodiments, the ESD circuit includes a diode clamp, a first active clamp circuit, and a second active clamp circuit. The diode clamp circuit is coupled to an I/O pad, a power supply pad, and a ground pad, and provides protection against a first set of ESD test scenarios. The first active clamp circuit is coupled to the I/O pad, the power supply pad, and the ground pad, and provides protection against ESD currents resulting from the application of a high positive voltage applied to the I/O pad with respect to the ground pad by clamping the I/O pad voltage without turning on the diode clamp circuit during the ESD event. The second active clamp circuit is coupled to the power supply pad and the ground pad, and provides protection against other ESD events.

For some embodiments, the ESD protection circuit is embedded within the IC device, which typically undergoes ESD testing before and/or after packaging. During the ESD testing, forced ESD events are imposed on the IC device to ensure the device's resilience against a variety of ESD events (e.g., simulating handling of the chip by people). More specifically, for ESD tests in which a high positive voltage spike is applied to the I/O pad with respect to the ground pad, the first active clamp circuit is configured to safely pass an ESD current to ground potential through a path separate from the diode clamp circuit, thereby precluding the I/O pad voltage from increasing to unacceptable levels that can damage the I/O circuit. In other forced ESD event scenarios, the diode clamp circuit and/or the second clamp circuit may be used to safely discharge ESD currents to ground potential, as discussed in more detail below.

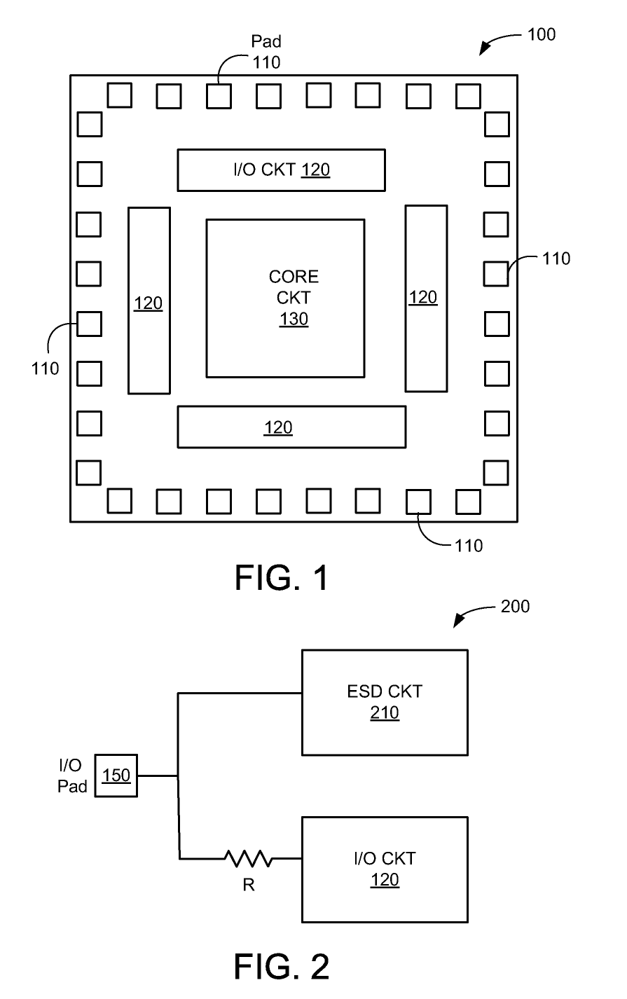

FIG. 1 is a block diagram of an integrated circuit 100 including a plurality of pads 110, one or more I/O circuits 120, and a core circuit 130. The core circuit 130 is responsible for main functions of the circuit 100 and is coupled through conducting paths (e.g., one or more metal layers, not shown in FIG. 1) to the I/O circuits 120, which are in turn coupled (e.g., directly via wire bonds or indirectly through other circuit elements) to one or more of the pads 110. The pads 110 may include I/O pads, power supply pads (hereinafter “VDD pads”), and ground pads. Each of the pads 110 is susceptible to ESD events. The I/O circuit 120 may include various interface circuitry including, for example, one or more drivers, buffers, multiplexers, de-multiplexers, and the like.

FIG. 2 is a block diagram of a circuit 200 including the I/O circuit 120 of FIG. 1 connected to an I/O pad 150 and protected by an ESD circuit 210. The I/O circuit 120 is coupled to the I/O pad 150 through a resistor R, which may include a resistance of a conducting path such as a metal connector that connects the I/O circuit 120 to the I/O pad 150. The ESD circuit 210 not only protects the I/O circuit 120 and the I/O pad 150 against potential ESD events but, as will be discussed in more detail below, also protects the VDD and ground pads as well. Although not shown in FIG. 2, the ESD circuit 210 is implemented along with the I/O circuit 120 on the integrated circuit 100 of FIG. 1.

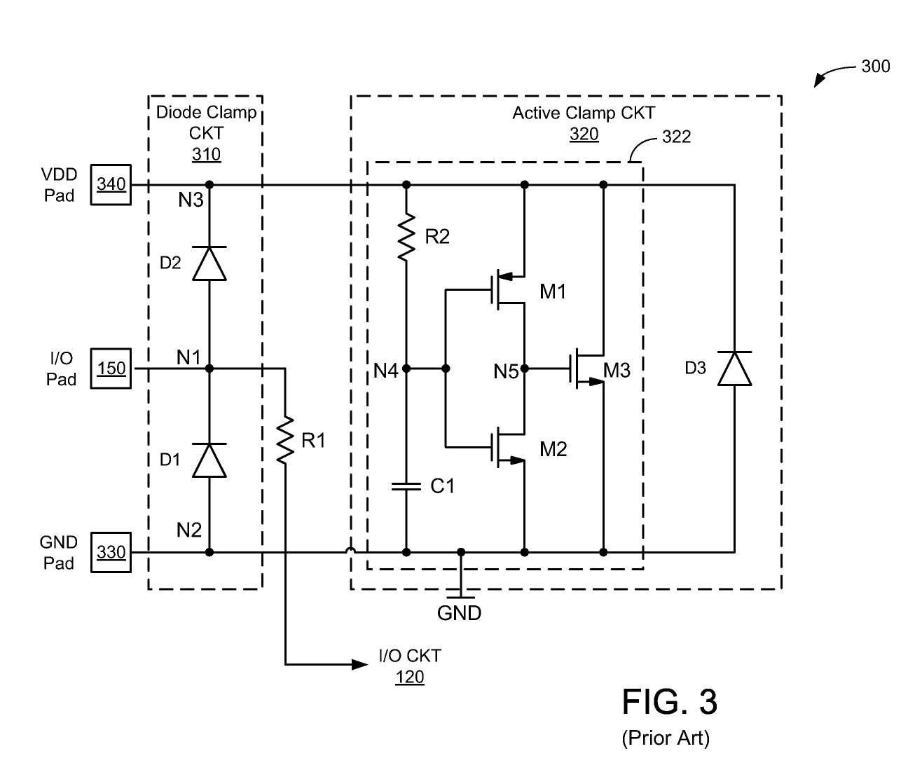

FIG. 3 is a schematic diagram of a conventional ESD circuit 300 connected to I/O pad 150, a VDD pad 340, and a ground pad 330. ESD circuit 300 includes a diode clamp circuit 310 and an active clamp circuit 320. The diode clamp 310 includes diodes D1 and D2, which can be implemented in a well-known manner (e.g., via MOS or bipolar devices). Diode D1 is connected between the I/O pad 150 (at node N1) and ground pad 330 (at node N2). Diode D2 is connected between I/O pad 150 and VDD pad 340 (at node N3). The I/O pad 150 is also connected to the I/O circuit 120 via a resistor R1. Node N2 is also coupled to an internal ground potential GND of the circuit 300.

The active clamp 320 includes a CMOS inverter formed by a PMOS transistor M1 and an NMOS transistor M2, a bias resistor R2, a bias capacitor C1, an NMOS transistor M3, and a diode D3. Resistor R2 and capacitor C1 are connected in series between VDD pad 340 and ground pad 330, and are coupled to each other at a node N4. Transistors M1 and M2 are connected in series between VDD pad 340 and ground pad 330, and have gate terminals jointly connected to node N4. Drain terminals of transistors M1 and M2 are connected to a node N5, which in turn is connected to a gate terminal of transistor M3. Transistor M3 is coupled between VDD pad 340 and ground GND.

In normal operation of circuit 300, capacitor C1 is charged through resistor R2 towards VDD. When the voltage at node N4 reaches the threshold voltage of NMOS transistor M2, transistor M2 turns on and pulls the gate of transistor M3 low towards ground potential, thereby maintaining transistor M3 in a non-conductive state. Transistor M1 remains non-conductive as long as the voltage level at its source terminal does not exceed VDD by a threshold voltage VT1 of transistor M1. Diode D3 is non-conductive, and typically turns on only during a negative ESD event, as described in more detail below.

During an ESD testing of an IC device within which ESD circuit 300 is implemented (e.g., IC device 100 of FIG. 1), a number of different ESD test scenarios are applied to the device. These ESD test scenarios emulate a variety of possible ESD events that can happen during handling and/or normal operation of the IC device. In each test scenario, one of the device pads 110 (e.g., I/O pad 150, VDD pad 340, or ground pad 330) is tested by applying a high voltage pulse (e.g., having an amplitude of the order of KV) with limited duration (e.g., nanoseconds) between that pad and another pad (hereinafter referred to as “zapping” one pad with respect to the other one). ESD test scenarios may involve positive and negative zaps. The other pad not used in the test is kept floating (i.e., not connected to any voltage source or external ground). For example, for test scenarios in which I/O pad 150 is zapped with respect to ground pad 330, the VDD pad 340 will be floating. Some of the important test scenarios include positive and negative zapping of I/O pad 150 with respect to both the ground pad 330 and the VDD pad 340, and include positive and negative zapping of VDD pad 340 with respect to the ground pad 330.

During a positive zapping of I/O pad 150 with respect to VDD pad 340, a high positive voltage differential is applied between VDD pad 340 and I/O pad 150 (e.g., such that the voltage of I/O pad 150 is several kV greater than the voltage of VDD pad 340), diode D2 diverts the resulting ESD current from I/O pad 150 to ground GND.

During a negative zapping of I/O pad 150 with respect to VDD pad 340, diode D2 remains off, and diode D1 turns on to conduct the corresponding ESD current to ground GND.

During a positive zapping of VDD pad 340 with respect to ground pad 330, none of the diodes D1-D3 are not conducting, and active clamp 322 conducts the corresponding ESD current to ground GND. More specifically, the positive VDD pad 340 with respect to ground pulls the source of transistor M1 towards VDD causing transistor M1 to conduct, thereby turning on transistor M3. As a result, M3 provides a path from VDD pad 150 to GND.

During a negative zapping of VDD pad 340 with respect to ground pad 330, diodes D1 and D2 remain non-conductive, and diode D3 turns on to provide a path for the corresponding ESD current to ground GND.

During a positive zapping of I/O pad 150 with respect to ground pad 330, diode D2 turns on and conducts the ESD current to ground GND through portion 322 of the ESD circuit 300. More specifically, transistor M1 turns on and pulls the gate of transistor M3 high towards VDD, thereby turning on transistor M3. As a result, transistor M3 provides a path from I/O pad 150 to ground GND via diode D2 for the ESD current. Transistor M3 is typically sized to conduct a maximum surge current (e.g., 1.5 Amps) while maintaining a limited voltage drop (e.g., 2 V) across its drain-source terminals. Accordingly, the potential at node N1 is clamped to a potential V1=V2+V3, where V2 is the voltage drop across the conduction diode D2 (e.g., 0.7 V) and V3 is the voltage drop across the drain and source terminals of transistor M3 (e.g., 2 V). Unfortunately, the resulting potential at node N1 may not be acceptable because it may cause damage to the I/O circuit 120.

Thus, although effective in protecting the I/O circuit 120 during many test scenarios, ESD circuit 300 may fail to adequately protect the I/O circuit 120 during a positive zapping of I/O pad 150 with respect to ground pad 330. The deficiencies of ESD circuit 300 in protecting the I/O circuit 120 from ESD currents resulting from the positive zapping of I/O pad 150 with respect to ground pad 330 are remedied by the ESD circuits configured in accordance with the present embodiments.

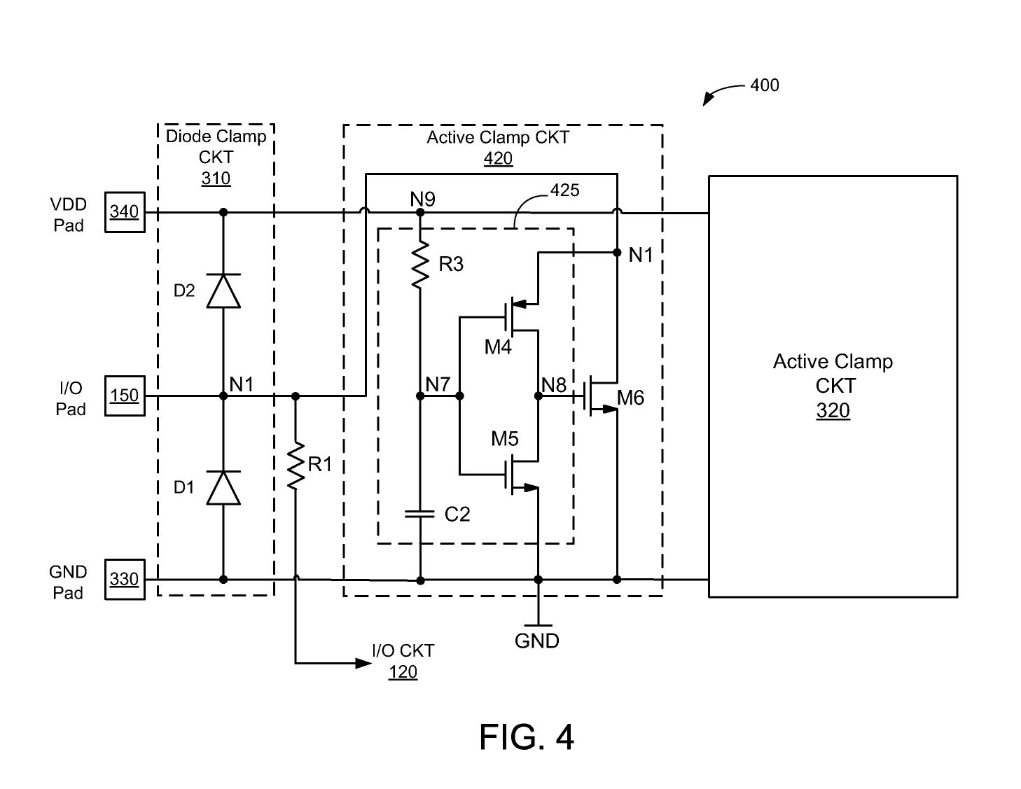

FIG. 4 is a schematic diagram of an ESD circuit 400 in accordance with some embodiments. The ESD circuit 400 includes the diode clamp 310 of FIG. 3, the active clamp 320 of FIG. 3, and an active clamp circuit 420. For purposes of discussion herein, active clamp circuit 420 is sometimes referred to as the first active clamp, and the active clamp circuit 320 is sometimes referred to as the second active. Active clamp 420 includes a driver circuit 425 and a pass transistor M6. The driver 425 includes a CMOS configuration formed by a PMOS transistor M4 and an NMOS transistor M5, as well as a resistor R3 and a capacitor C2. Transistors M4 and M5 are connected in series between node N1 and ground potential, and thus provide a series connection between I/O pad 150 and ground pad 330. The gates of transistors M4 and M5 are connected to node N7, which is coupled to VDD pad 340 via resistor R3 and coupled to ground pad 330 via capacitor C2. The drains of transistors M4 and M5 are connected (at node N8) to the gate of pass transistor M6, which is connected between the I/O pad 150 (at node N1) and ground pad 330. Thus, transistor M6 is connected in parallel with transistors M4-M5 between node N1 and ground potential. For other embodiments, transistor M6 can be replaced by a bipolar transistor.

The driver circuit 425 selectively drives transistor M6 into saturation (or alternatively into the active region if transistor M6 is a bipolar transistor) in response to various voltage differential applied to the pads 150, 330, and 340. When driven by driver circuit 425, transistor M6 can conduct a relatively large surge current (e.g., 1.5 Amps) while maintaining a limited voltage drop (e.g., 2 V) across its drain and source regions. For example, when VDD pad 340 is floating, the voltage across capacitor C2 drops to nearly zero because there is no other path for any non-transient current to charge this capacitor, thereby pulling node N7 low toward ground potential. In response thereto, transistor M5 remains off, and transistor M4 turns on to pull node N8 high towards node N1. The high voltage at node N8 turns transistor M6 on, thereby providing a discharge path between I/O pad 150 and ground potential.

Conversely, when VDD pad 340 is connected to a supply voltage (e.g., during normal operation of the IC device within which ESD circuit 400 is implemented), the capacitor C2 charges node N7 high towards VDD via resistor R3, thereby turning on transistor M5 and turning off transistor M4. The conductive state of transistor M5 pulls the gate of transistor M6 low towards ground potential, thereby maintaining transistor M6 in a non-conductive state.

Now consider the scenario of positive zapping of I/O pad 150 with respect to ground pad 330, for which conventional active clamp 320 of FIG. 3 may fail to adequately protect the I/O circuit 120 from ESD currents (as discussed above with respect to FIG. 3). More specifically, during this ESD test scenario, the I/O pad 150 is zapped with a large positive voltage relative to ground pad 330, and VDD pad 340 remains floating. The capacitor C2 AC couples node N7 to ground GND, which in turn pulls the gates of PMOS transistor M4 and NMOS transistor M5 low to ground potential to maintain transistor M5 in a non-conductive state during the ESD test. The positive zap voltage applied to I/O pad 150 increases the voltage of node N1 to a level that greater than the threshold voltage VT4 of PMOS transistor M4, thereby resulting in the gate of PMOS transistor M4 being at least one threshold voltage VT4 lower than the source of transistor M4. As a result, PMOS transistor M4 turns on and pulls the gate of NMOS transistor M6 high toward the zap voltage applied to I/O pad 150 at node N1. In response thereto, transistor M6 turns on and provides a discharge path from I/O pad 150 to ground GND independently of diode D2 of the diode clamp circuit 310 (e.g., without using diode D2 of the diode clamp circuit 310).

Accordingly, in contrast to the active clamp 320 of FIG. 3, the active clamp 420 safely discharges the ESD current resulting from the positive zapping of I/O pad 150 with respect to ground pad 330 without turning on diode D2, which is advantageous because active clamp circuit 420 can successfully clamp node N1 at a voltage level that is independent of the voltage drop across diode D2. In this manner, active clamp 420 achieves a significant improvement over the conventional active clamp 320 because the active clamp 420 clamps node N1 at a voltage that is a diode drop (e.g., the voltage drop across diode D2 when diode D2 is conductive) less than the voltage of node N1 clamped by conventional active clamp 320. For example, if the voltage drop across diode D2 during is be 0.7 V and the voltage drop across source-drain of transistor M6 is equal to 2 V, then a reduction of 0.7/(2+0.7)≈%26 in the clamped voltage at node N1 is achieved by addition of the active clamp 420. It is interesting to note that, as discussed in more detail below, the addition of the active clamp 420 does not impose any additional loading to the I/O circuit 120.

In normal operation, when VDD pad 340 is connected to a power supply, as described above, the capacitor C2 is charged toward VDD and almost turns on transistor M5. However, unless the source terminal of transistor M4 (i.e., node N1) is driven to a level of VT4+VDD, where VT4 is the threshold voltage of transistor M4, transistor M4 does not turn on, and therefore, no current will pass through any of the transistors M4, M5, and M6. The impedance of active clamp 420 seen from node N1 is in the order of leakage resistance of transistor M6. Therefore, during normal operation, active clamp 420 does not load the I/O circuit 120, which is indeed a desirable feature of ESD circuit 400.

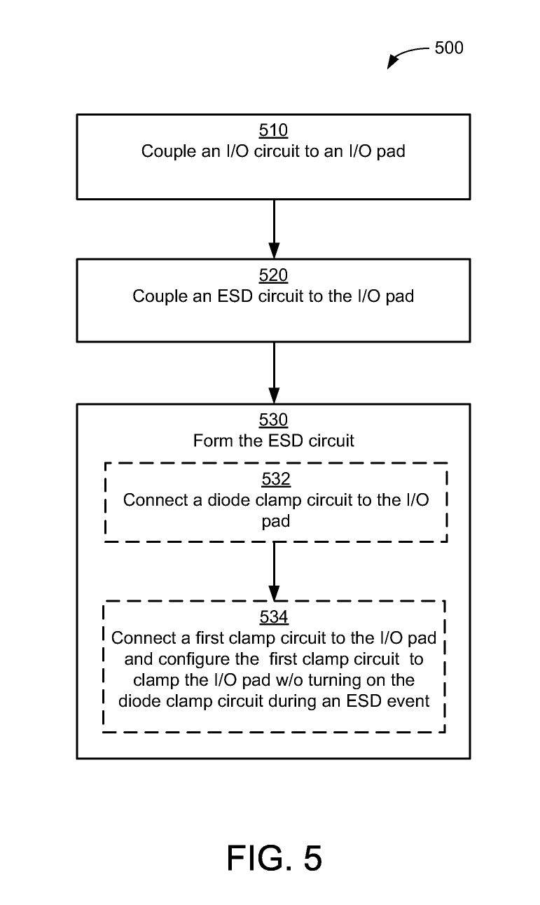

FIG. 5 is a flow diagram illustrating a method 500 for protecting the I/O circuit 120 of FIG. 4 against an ESD event in accordance with some embodiments. The method 500 starts by coupling the I/O circuit 120 to the I/O pad 150, both of FIG. 4. (510) Next, the ESD circuit 400 is coupled to the I/O pad 150 to protect the I/O circuit 120 against ESD events. (520) The ESD circuit 400 is formed (530) by connecting the diode clamp 310 to the I/O circuit 120. (532) The diode clamp 310 will operate to provide a path for ESD currents in some test scenarios and actual ESD events, as discussed above with respect to FIG. 3. The ESD circuit 400 includes a first active clamp circuit (i.e., active clamp 420), which is connected to the I/O circuit 150 at node N1. The active clamp 420 is configured to clamp the I/O pad 150 (also the I/O circuit 120) without turning on the diodes of the diode clamp 310, during the positive zapping of the I/O pad 150 with respect to ground, as described in more detail above with respect to FIG. 4. (534) The active clamp 420 clamps the I/O circuit 150 to a potential level that is less than the potential level that ESD circuit 300 of FIG. 3, as discussed above. Thus, presently disclosed ESD circuit 400 shows a significant improvement over the conventional ESD circuit 300.

In the foregoing specification, the present embodiments have been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense.

What is claimed is:

1. An integrated circuit device, comprising:
an input-out (I/O) pad;
an I/O circuit coupled to the I/O pad; and
an electro-static discharge (ESD) circuit coupled to the I/O pad, the ESD circuit including:
a diode clamp circuit; and
a first active clamp circuit, wherein the first active clamp circuit is configured to clamp the I/O pad without turning on the diode clamp circuit during a first ESD event.

2. The device of claim 1, wherein the first ESD event comprises applying a positive voltage to the I/O pad with respect to a ground pad of the integrated circuit device.

3. The device of claim 1, wherein the diode clamp comprises a first diode connected between the I/O pad and a supply voltage pad, and wherein the first active clamp circuit is configured to clamp the I/O pad at a predetermined voltage that is independent of a voltage drop across the first diode.

4. The device of claim 1, wherein the first active clamp circuit is configured to pass an ESD current caused by the first ESD event from the I/O pad to ground potential through a discharge path that is separate from the diode clamp circuit.

5. The device of claim 4, wherein the first active clamp circuit comprises a pass transistor to provide the separate path, wherein the pass transistor is connected in series between the I/O pad and ground potential and has a gate responsive to a voltage differential between a power supply pad and ground potential.

6. The device of claim 5, wherein the first active clamp circuit further comprises a driver circuit coupled to the I/O pad and configured to drive the pass transistor.

7. The device of claim 1, wherein the active clamp circuit comprises:
a pass transistor connected between the I/O pad and ground potential and having a gate; and
a driver circuit including a PMOS transistor and an NMOS transistor connected in series between the I/O pad and ground potential, wherein the PMOS transistor and the NMOS transistor have commonly-coupled drains that are connected to the gate of the pass transistor, and the NMOS transistor is self-biased.

8. The device of claim 7, wherein the active clamp circuit further comprises:
a resistor connected between a power supply pad and commonly-coupled gates of the PMOS and NMOS transistors; and
a capacitor connected between ground potential and the commonly-coupled gates of the PMOS and NMOS transistors.

9. The device of claim 7, wherein the driver circuit is active only during the first ESD event.

10. The device of claim 1, further comprising a second clamp circuit connected between the supply voltage pad and ground potential, and configured to protect the I/O circuit using the diode clamp circuit during a second ESD event.

11. The device of claim 12, wherein the second ESD event comprises applying a negative voltage to the I/O pad with respect to the supply voltage pad.

12. An integrated circuit device, comprising:
an input-out (I/O) pad;
an I/O circuit coupled to the I/O pad; and
an electro-static discharge (ESD) circuit coupled to the I/O pad, the ESD circuit including:
a diode clamp circuit connected between a power supply pad and a ground pad; and
a first active clamp circuit coupled to the I/O pad and the I/O circuit, wherein the first active clamp circuit is configured to provide a discharge current path that is separate from the diode clamp circuit for a first ESD event, wherein the first ESD event comprises applying a positive voltage to the I/O pad with respect to a ground pad of the integrated circuit device.

13. The device of claim 12, wherein the diode clamp comprises a first diode connected between the I/O pad and the power supply pad, and wherein the first active clamp circuit is configured to clamp the I/O pad at a predetermined voltage that is independent of a voltage drop across the first diode.

14. The device of claim 12, wherein the first active clamp circuit is configured to pass an ESD current caused by the first ESD event from the I/O pad to ground potential through a discharge path that is separate from the diode clamp circuit.

15. The device of claim 14, wherein the first active clamp circuit comprises a pass transistor connected in series between the I/O pad and ground potential and has a gate responsive to a voltage differential between a supply voltage pad and ground potential.

16. The device of claim 15, wherein the first active clamp circuit further comprises a driver circuit coupled to the I/O pad and configured to drive the pass transistor.

17. The device of claim 12, wherein the active clamp circuit comprises:
a pass transistor connected between the I/O pad and ground potential and having a gate; and
a driver circuit including a PMOS transistor and an NMOS transistor connected in series between the I/O pad and ground potential, wherein the PMOS transistor and the NMOS transistor have commonly-coupled drains that are connected to the gate of the pass transistor, and wherein the NMOS transistor is self-biased.

18. The device of claim 17, wherein the active clamp circuit further comprises:
a resistor connected between a supply voltage pad and commonly-coupled gates of the PMOS and NMOS transistors; and
a capacitor connected between ground potential and the commonly-coupled gates of the PMOS and NMOS transistors.

19. The device of claim 12, further comprising a second clamp circuit connected between the supply voltage pad and ground potential, and configured to protect the I/O circuit using the diode clamp circuit during a second ESD event.

20. The device of claim 19, wherein the second ESD event comprises applying a negative voltage to the I/O pad with respect to the supply voltage pad.
